(19) United States
(12) Patent Application Publication
(10) Pub. No.: US 2009/0304045 A1
(43) Pub. Date: Dec. 10, 2009

(54) Method and Device for Transmitting Data Between a Communication Network Unit and a Plurality of Communication Devices

(76) Inventors: Zhongding Lei, Singapore (SG); Ying Chang Liang, Singapore (SG); Xiaoming Peng, Singapore (SG); Po Shin Francois Chin, Singapore (SG)

Correspondence Address: CHOATE, HALL & STEWART LLP, TWO INTERNATIONAL PLACE, BOSTON, MA, 02110, US

(21) Appl. No.: 12/160,157

(22) PCT Filed: Jan. 9, 2007
(86) PCT No.: PCT/SG2007/000007

§ 371 Date: May 1, 2009

Related U.S. Application Data
(60) Provisional application No. 60/757,283, filed on Jan. 9, 2006.

(51) Int. Cl. H04B 1/69; H04B 1/707; H04B 7/00

(52) U.S. Cl. 375/140; 455/509; 375/E01.001; 375/260

(57) ABSTRACT

A method for transmitting data between a communication network unit and a plurality of communication devices is provided, comprising using a plurality of carrier signals grouped into at least one carrier signal group, determining a subset of communication devices of the plurality of communication devices, and using the at least one carrier signal group for data transmission between the communication network and the communication devices of the subset of communication devices.

The present application claims the benefit of U.S. provisional application 60/757,283 (filed on 9 Jan. 2006), the entire contents of which is incorporated herein by reference for all purposes.

The present invention refers to a method for transmitting data between a communication network unit and a plurality of communication devices, as well as to a respective device.

Due to the advent of wireless communication technology, frequency spectrum is becoming an extremely precious commodity. It is becoming increasingly difficult to obtain available frequency spectrum for new wireless communication technologies and applications. It is therefore an objective nowadays to maximize the use of all existing allocated frequency spectrum.

An approach which can be used to achieve this objective of maximizing the use of all existing allocated frequency spectrum is a concept called multi-user communications. How multi-user communications works can be described as follows.

In multi-user communications, a number of users (with each user having a communication device) simply share the same frequency channel resource. For example, a user A may use the frequency channel resource for T_{A} seconds, following which a user B may use the frequency channel resource for T_{B} seconds, following which a user C may use the frequency channel resource for T_{C} seconds, before user A gets the opportunity to use the frequency channel resource again. This example is a simple illustration of a time division multiple access (TDMA) multi-user communication technology. Other multi-user communication technologies includes frequency division multiple access (FDMA), code division multiple access (CDMA), and orthogonal frequency division multiple access (OFDMA).

For all multi-user communication technologies, it is desirable to have the feature of “orthogonality between users”, so that multiple access interference (MAI) between users can be easily reduced using low complexity receivers. However, it is known that only two multi-user communication technologies have this feature of “orthogonality between users”, namely, multi-carrier direct sequence code division multiple access (MC-DS-CDMA) and OFDMA. In this regard, MC-DS-CDMA achieves the feature of “orthogonality between users” in the code domain, while OFDMA achieve the feature of “orthogonality between users” in the frequency domain.

A third multi-user communication technology to have this feature of “orthogonality between users” is provided according to one embodiment of the present invention, which is provided by the method and devices as defined in the respective independent claims of the present application.

In a first aspect of the invention, a method for transmitting data between a communication network unit and a plurality of communication devices comprising using a plurality of carrier signals grouped into at least one carrier signal group, determining a subset of communication devices of the plurality of communication devices, and using the at least one carrier signal group for data transmission between the communication network and the communication devices of the subset of communication devices.

In a second aspect of the invention, a device for allocating a plurality of carrier signals grouped into at least one carrier signal group for transmitting data between a communication network unit and a plurality of communication devices comprising a determining unit determining a subset of communication devices of the plurality of communication devices, and an allocating unit allocating the at least one carrier signal group for data transmission between the communication network and the communication devices of the subset of communication devices.

Illustratively, a group of carrier signals, previously used by only one communication device, is now made available to be shared by a determined number of communication devices. In this regard, the sharing of the group of carrier signals is enabled by each communication device having been assigned a unique set of spreading sequences, which is used for spreading its transmitted symbols. Also, the number of communication devices allowed to share in using the group of carrier signals is dynamically adjusted, and is determined based on the channel response determined for each communication device. A basic idea of one embodiment of the invention may be seen in the combination of OFDMA and CDMA.

Embodiments of the invention emerge from the dependent claims.

As used herein, the communication network unit may be a suitably located station for transmitting and receiving data from a plurality of communication devices, such as a mobile radio base station, for example.

In a similar manner, the communication device may be, but is not limited to, a wireline communication device, a powerline communication device, a radio communication device, a mobile radio communication device, a satellite radio communication device, a terminal communication device or a Consumer Premise Equipment device.

While the method for transmitting data between a communication network unit and a plurality of communication devices provided would probably be more commonly used in wireless communications, the said method may also be used in non-wireless communications, such as powerline communications, for example. Accordingly, the communication device may also be, but is not limited to, a wireline communication device or a powerline communication device.

In one embodiment, a number of communication devices to which the at least one carrier signal group should be allocated is determined and the subset of communication devices of the plurality of communication devices is determined such that it comprises the number of communication devices.

This embodiment may be illustrated in the following example. The number of communication devices, which is allowed to use the at least one carrier signal group determined, is first determined and is denoted by N. Following which, N suitable communication devices are then determined and allowed to use the at least one carrier signal group for data transmission.

In one embodiment, a transmission characteristic of a communication channel used for transmission of at least one of the carrier signals of the at least one carrier signal group is determined.

In one embodiment, the number of communication devices to which the at least one carrier signal group should be allocated is determined based on the transmission characteristic.

This embodiment may be illustrated as follows. In the earlier example, N suitable communication devices are determined and allowed to use the at least one carrier signal group for data transmission. In this embodiment, the criterion used to determine whether a communication device is suitable or not, is the transmission characteristic.

In one embodiment, the transmission characteristic is measured and the subset of communication devices is determined based on the transmission characteristic at least substantially fixed time intervals.

In this embodiment, the transmission characteristic is measured at substantially fixed intervals. Once the transmission characteristic is measured, it will be used in order to determine the number of communication devices which is allowed to use the at least one carrier signal group, N.

If the new value of N is larger compared to the previous value of N, then additional suitable communication devices may be added to the subset of communication devices which is allowed to use the at least one carrier signal group, such that the number of communication devices in the subset of communication devices is N. On the other hand, if the new value of N is smaller compared to the previous value of N, then a number of suitable communication devices may be removed from the subset of communication devices which is allowed to use the at least one carrier signal group, such that the number of communication devices in the subset of communication devices is N.

In one embodiment, the transmission characteristic is the channel response of the communication channel.

The transmission characteristic may not only be measured at fixed intervals, but also at other predefined events happening during the operation of the respective communication system, for example when the number of communication devices requesting transmission resources rises above or falls below a predefined threshold. Illustratively, the number of communication devices allocated to the same carrier signal group is dynamically set during the operation of the respective communication system.

In one embodiment, the number of communication devices is being dynamically adjusted based on the transmission characteristic determined comprising determining the transmission characteristic for each communication device in the subset of communication devices, determining the largest difference between the transmission characteristics of a pair of communication devices, determining, whether the largest difference between the transmission characteristics of a pair of communication devices is below a predetermined threshold. In the case where the largest difference between the transmission characteristics of a pair of communication devices is below a first predetermined threshold, then the number of communication devices being increased. In the case where the largest difference between the transmission characteristics of a pair of communication devices is above the first predetermined threshold, but is below a second predetermined threshold, then the number of communication devices being unchanged. In the case where the largest difference between the transmission characteristics of a pair of communication devices is above the second predetermined threshold, then the number of communication devices being decreased.

In one embodiment, to each communication device of the subset of communication devices a set of spreading sequences is allocated and the data transmitted between the communication network unit and the communication device using the at least one carrier signal group is spread using the set of spreading sequences, wherein the set of spreading codes comprises at least one spreading code.

In this embodiment, in the subset of communication devices which is allowed to use the at least one carrier signal group, each communication device is allocated a set of spreading sequences. As the data transmission between the communication network unit and each communication device in the subset of communication devices occupies the same signal space (or frequency channel resource), the data transmission of one communication device may be differentiated from that of another communication device using the set of spreading codes. In this regard, the data transmission between the communication network unit and each communication device in the subset of communication devices is spread using the set of spreading sequences allocated to each communication device.

In one embodiment, the set of spreading sequences allocated to each communication device of the subset of communication devices being different from all the sets of spreading sequences allocated to other communication devices of the subset of communication devices.

In one embodiment, the set of spreading sequences allocated to each communication device of the subset of communication devices being orthogonal or at least substantially orthogonal from all the sets of spreading sequences allocated to other communication devices of the subset of communication devices.

In one embodiment, a transmission characteristic of a communication channel used for transmission of at least one of the carrier signals of the at least one carrier signal group is determined and the length of the spreading sequences allocated to each communication device of the subset of communication devices is chosen according to the transmission characteristic of the communication channel.

In one embodiment, the at least one carrier signal group forms a contiguous frequency range.

In this embodiment, the plurality of carrier signals grouped into the at least one carrier signal group may form a contiguous frequency range. It is also possible that the plurality of carrier signals grouped into the at least one carrier signal group may not form a contiguous frequency range. In this case, a few carrier signals may form a small contiguous frequency range block, and the at least one carrier signal group may comprise a few small contiguous frequency range blocks, where each small contiguous frequency range block is separated from other small contiguous frequency range blocks.

In one embodiment, the method provided further comprises using a multiple access transmission technology. In another embodiment, the multiple access transmission technology being selected from a group of multiple access transmission technologies consisting of code division multiple access, or orthogonal frequency division multiple access.

In one embodiment, the method provided further comprises grouping the plurality of carrier signals into at least one carrier signal group.

In one embodiment, the method provided further comprises arranging the data symbols of the data transmission into a data symbol block, and multiplying the data symbol block with a pre-transform matrix. For example, the pre-transform matrix may be, but is not limited to, a Walsh Hadamard matrix, a Fourier transform matrix, or a unitary matrix being product of a Fourier transform matrix and a phase rotation diagonal matrix.

It can be seen from the method provided by the invention has the following advantages.

Firstly, as desired, the feature of “orthogonality between users” can easily be achieved in embodiment of the invention. Accordingly, when the method provided by the invention is used, multiple access interference (MAI) between users can be easily reduced using low complexity receivers.

Secondly, the method provided by the invention allows the number of communication devices using the at least one carrier signal group to be dynamically adjusted, for example based on a measured transmission characteristic. Accordingly, it is possible to optimize channel capacity based on the condition of the communication channel.

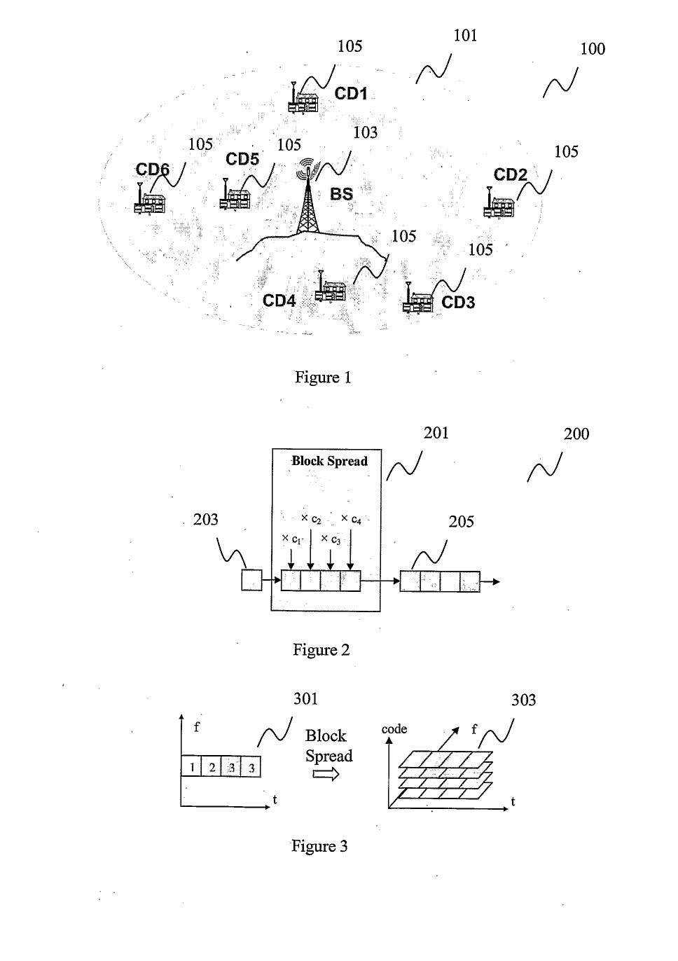

FIG. 1 shows a communication system according to an embodiment of the invention.

FIG. 2 shows a block diagram which illustrates on how block spreading is carried out according to an embodiment of the invention.

FIG. 3 shows an illustration of the effect of block spreading in the frequency, time and code domains, according to an embodiment of the invention.

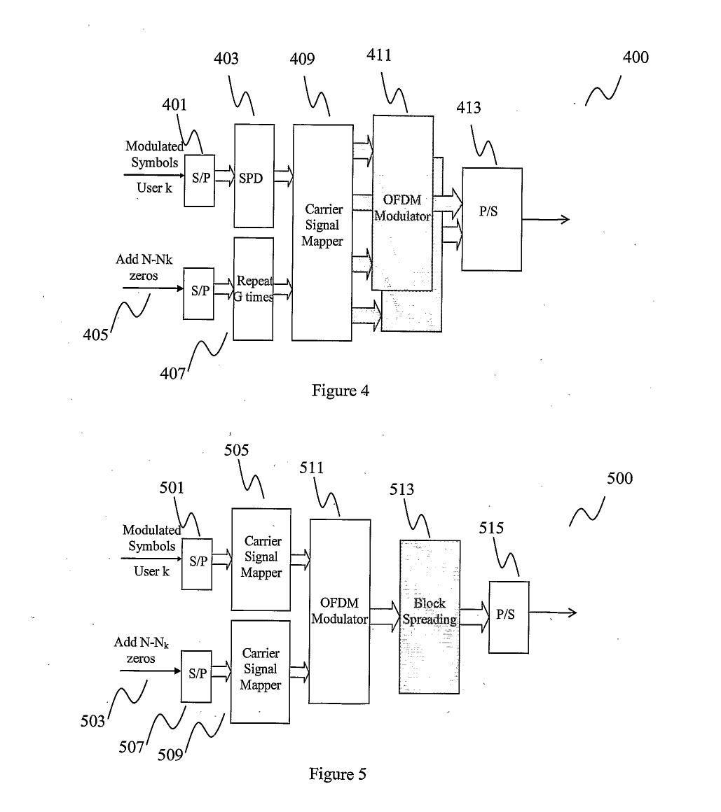

FIG. 4 shows a block diagram of an uplink path transmitter with an implementation of block spreading, according to an embodiment of the invention.

FIG. 5 shows a block diagram of an uplink path transmitter with another implementation of block spreading, according to an embodiment of the invention.

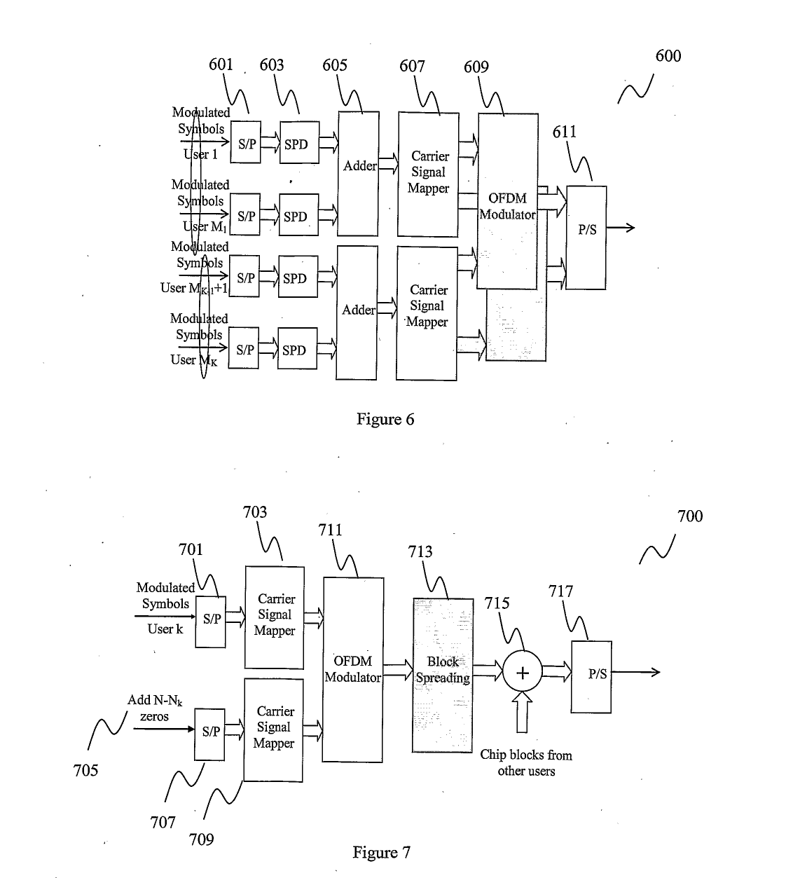

FIG. 6 shows a block diagram of a downlink path transmitter with an implementation of block spreading, according to an embodiment of the invention.

FIG. 7 shows a block diagram of a downlink path transmitter with another implementation of block spreading, according to an embodiment of the invention.

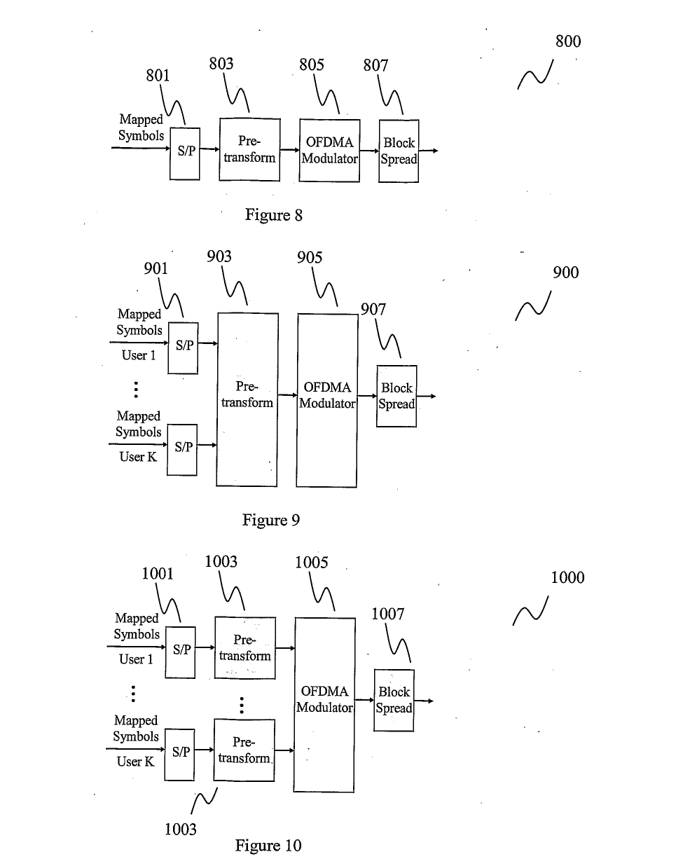

FIG. 8 shows a block diagram of a transmitter with an implementation of block spreading along with a pre-transform block, according to an embodiment of the invention.

FIG. 9 shows a block diagram of a downlink transmitter with an implementation of block spreading along with a pre-transform block, according to an embodiment of the invention.

FIG. 10 shows a block diagram of a downlink transmitter with another implementation of block spreading along with a pre-transform block, according to an embodiment of the invention.

FIG. 1 shows a communication system 100 according to an embodiment of the invention.

The communication system 100 comprises a communication system cell 101, which comprises a base station (BS) 103 and a plurality of communication devices 105.

In this illustration, the base station (BS) 103 is the communication network unit. This illustration also shows an example of a simple communication system where the data transmission between the base station (BS) 103 and the plurality of communication devices 105 is carried out using the method for transmitting data between a communication network unit and a plurality of communication devices provided.

In the subsequent description, the method for transmitting data between a communication network unit and a plurality of communication devices provided will be discussed using an OFDMA based system as an illustrated example.

FIG. 2 shows a block diagram 200 which illustrates on how block spreading is carried out according to an embodiment of the invention.

A series of steps in the method for transmitting data between a communication network unit and a plurality of communication devices provided implements a feature called block spreading. As indicated by its name, in block spreading, the spreading process is performed at the block level. For example, with an OFDMA system, block spreading is performed at the OFDMA symbol level.

As illustrated in FIG. 2, block spreading is performed by the block spreading unit 201. An input symbol 203 is taken by the block spreading unit 201. In this case, the input symbol 203 is replicated 3 times (for a total of 4 symbols), and each replica of the input symbol 203 is multiplied with a different spreading sequence. Each spreading sequence is taken from the set of spreading sequences allocated to a specific communication device (or user), and each set of spreading sequences is unique. The block spreading unit 201 outputs 4 symbols which have been block spread.

FIG. 3 shows an illustration of the effect of block spreading in the frequency, time and code domains, according to an embodiment of the invention. In more detail, FIG. 3 shows the input symbols 301 before being processed by a block spread unit (for example, the block spread unit 201 of FIG. 2) and the output symbols 303 after being processed by the block spread unit.

The input symbols 301 are not spread, and hence, may be represented only in the frequency and time domains. If the input symbols 301 were spread, then they may also be represented in the code domain as well. Accordingly, the code domain is not relevant to the input symbols 301.

Using the block spread unit 201 of FIG. 2, each of the input symbols 301 will result in an output of 4 symbols which have been block spread. Since there are 4 input symbols in total, there will be 16 output symbols, all of which have been block spread.

In addition, as each of the 4 replicas of the input symbol is spread with a spreading code (meaning that 4 spreading codes are used), accordingly, it can be seen that there are 4 levels on the code axis at the output symbols 303 side.

There are a few observations which can be made on block spreading from the illustrations of FIGS. 2 and 3.

Firstly, it can be seen from the input and the output of the block spreading unit 201 that each symbol has now been extended to 4 symbol duration. With this extension in transmission time, it is possible that the overall transmission time may become continuous, as illustrated in FIG. 3, for example.

Secondly, it can also be seen that instead of each communication device (or user) being allocated with a number of time slots in typical OFDMA systems, it is possible that each communication device (or user) be allocated with a number of spreading codes.

Thirdly, it can be seen that the data transmission rate with or without block spreading remains unchanged.

For example, in FIG. 3, four block spread data symbols are transmitted in one symbol duration, or in total, sixteen block spread data symbols are transmitted in four symbol durations. However, these sixteen block spread data symbols are obtained based on only four data symbols (as shown in FIG. 2). Therefore, the effective data transmission rate is still one data symbol per symbol duration.

In the case of an OFDMA system, there is only one spread data symbol transmitted in one symbol duration, or in total, there are also four spread data symbols transmitted over four symbol durations. In this case, each spread data symbol is obtained based on one data symbol. This means that the effective data transmission rate is only one data symbol per symbol duration. Accordingly, there is no change in data transmission rate with or without the use of block spreading.

Fourthly, it can also be seen that in order to keep the same total transmission power for data transmission, the instantaneous transmission power of the data transmission with block spreading is only ¼ of the instantaneous transmission power of the data transmission without block spreading.

Fifthly, it can be seen that with block spreading, it is possible to allow another group of communication devices (or users) to use the same frequency channel resource. This is where block spreading differentiates itself from a conventional OFDMA system. In a conventional OFDMA system, only one communication device is allowed to use a frequency channel resource. With block spreading, multiple communication devices are allowed to use the same frequency channel resource.

In this regard, the analogy of CDMA technology, where users can be differentiated by using spreading codes, applies to block spreading as well. In the case of block spreading, users are differentiated by using sets of spreading codes, with each set of spreading codes unique to each user.

The feature of “orthogonality between users” is provided by block spreading. However, with block spreading, in order to maintain “orthogonality between users” sharing in the use of the same frequency channel resource, it is a requirement that the channel responses for all the communication devices (or users) to be substantially static within the transmission interval of a group of block spread symbols.

Therefore, for communication devices (or users) operating in a channel with slow fading, the spreading factor G can be large. Otherwise, the spreading factor G should be kept small, for example, 4, 2 or 1. Since in one embodiment, the spreading factor and accordingly, the number of communication devices using the same subset of carrier signals is set according to the current behaviour of the communication channel (i.e. slow fading and fast fading) the block spreading scheme according to this embodiment of the invention is also called adaptive block spreading.

In this regard, it can be seen that in an extreme case, when G=1, only one user is allowed to use the frequency channel resource.

With regard to the term frequency channel resource which was used in discussing FIGS. 2 and 3, frequency channel resource refers the plurality of carrier signals grouped into the at least one carrier signal group. In OFDMA based systems, data transmission is carried out using a group of carrier signals (sometimes also referred to as sub-carriers).

It is possible that the plurality of carrier signals grouped into the at least one carrier signal group may form a contiguous frequency range. It is also possible that a plurality of carrier signals grouped into the at least one carrier signal group may not form a contiguous frequency range. In this case, a few carrier signals may form a small contiguous frequency range block, and the at least one carrier signal group may comprise a few small contiguous frequency range blocks, where each small contiguous frequency range block is separated from other small contiguous frequency range blocks.

FIG. 4 shows a block diagram of an uplink path transmitter 400 with an implementation of block spreading, according to an embodiment of the invention.

As used herein, an uplink transmission from a communication device refers to a transmission in the direction from the communication device to the communication network unit.

For example, the communication network unit may be a transmitting and/or receiving station, which is usually strategically located. In one embodiment, the communication network unit may be a base station.

In contrast to the uplink transmission, a downlink transmission to a communication device refers to a transmission in the direction from the communication network unit to the communication device.

In the uplink transmitter 400 with block spreading implemented on an OFDMA system shown in FIG. 4, the modulated symbols from communication device k are first passed to a serial to parallel (S/P) converter 401, generating Nₖ symbol outputs at one time, which can be described as

$${\overline{s}}_{k} = [ \begin{matrix}{s}_{k , 1} \\ ⋮ \\ {s}_{k , {N}_{k}}\end{matrix} ] \qquad ( 1 )$$

The Nₖ symbols are then block spread (SPD block 403) using a set of spreading codes which comprises at least one spreading code sequence, [c_{k,1} . . . c_{k,G}] with a spreading gain of G, generating G chip blocks as follows:

$${\overline{C}}_{k} = [ \begin{matrix}{s}_{k , 1} {c}_{k , 1} & … & {s}_{k , 1} {c}_{k , G} \\ ⋮ & … & ⋮ \\ {s}_{k , {N}_{k}} {c}_{k , 1} & … & {s}_{k , N} {c}_{k , G}\end{matrix} ] \qquad ( 2 )$$

At the same time, N-Nₖ zeros are inserted (405), and repeated G times (407), in order to generate G null chip blocks. In the case where the data transmission for the communication device k does not have enough data to fill all the carrier signals, the zeros are required for filling up the remaining carrier signals.

The i^{th} chip block of user k, which is the i^{th} column of matrix C̅ₖ, together with the i^{th} null chip block, is passed to the carrier signal mapper 409, where the outputs of which are used to form the i^{th} OFDM block at the OFDM modulator 411. As there are G OFDM blocks to be formed, accordingly there are G OFDM modulators 411. The process of forming of the G OFDM blocks in this manner is called block spreading.

Finally, the chip blocks are then processed by a parallel to serial (P/S) converter 413, and then transmitted out through the antenna of the communication device.

FIG. 5 shows a block diagram of an uplink path transmitter 500 with another implementation of block spreading, according to an embodiment of the invention.

Similar to the implementation shown in FIG. 4, the modulated symbols from communication device k are first passed to a serial to parallel (S/P) converter 501, generating Nₖ symbol outputs at one time. At the same time, N-Nₖ zeros are inserted (503).

However, in this implementation, the Nₖ symbol outputs are then passed to a carrier signal mapper 505. In a similar manner, the N-Nₖ zeros inserted are first passed to a serial to parallel (S/P) converter 507, the outputs of which are passed to a second carrier signal mapper (509).

The outputs of the carrier signal mappers (505 and 509) are then processed by an OFDM modulator 511, the output of which is then passed to a block spreading block 513 with processing gain of G, generating G chip blocks. Let [c_{k,1} . . . c_{k,G}] be the spreading codes for user k, and

$${\overline{S}}_{k} = [ \begin{matrix}{S}_{k , 1} \\ ⋮ \\ {S}_{k , N}\end{matrix} ]$$

be the output of the OFDM modulator 511. The ith chip block output of the block spreading block 513 is given by

$${\overline{S}}_{k} {c}_{k , i} = [ \begin{matrix}{S}_{k , 1} {c}_{k , i} \\ ⋮ \\ {S}_{k , N} {c}_{k , i}\end{matrix} ] \qquad ( 3 )$$

The chip blocks are then processed by a parallel to serial (P/S) converter 515, and then transmitted out through the antenna of the communication device.

It can be seen that since Equation (3) holds for i from 1 to G, Equation (3) is the same as Equation (2). Accordingly, both the implementations in FIGS. 4 and 5 achieve the same effect on the signals transmitted.

It can also be seen that only one OFDM modulator is required in this implementation, compared to G OFDM modulators in the implementation shown in FIG. 4. Accordingly, this implementation may provide a significant amount of savings in terms of hardware complexity.

FIG. 6 shows a block diagram of a downlink path transmitter 600 with an implementation of block spreading, according to an embodiment of the invention.

The downlink transmitter of FIG. 6 is for a block spread OFDMA system, with K clusters of communication devices (or users), wherein there may be up to M communication devices in each cluster, i.e. in each cluster of communication devices that use the same group of carrier signals.

As mentioned earlier, block spreading is performed in order to provide “orthogonality between users” within each cluster. In more detail, the modulated symbols each communication device in cluster 1 (communication device (or user) 1 to communication device M₁) are first passed to a serial to parallel (S/P) converter 601, generating N₁ symbol outputs at one time. The N₁ symbols from each communication device are then spread (at the SPD block 603) using a set of spreading codes uniquely assigned to each communication device (where each spreading code has a spreading gain of G₁), generating G₁ chip blocks.

The chip blocks from all communication devices within the same cluster are then summed up at the adder block 605, to obtain the summed chip blocks for each cluster. Similarly, the summed chip blocks are formulated for the other clusters. The summed chip blocks for each cluster are then passed to the respective carrier signal mappers 607, followed by the OFDM modulator 609, and finally by the parallel to serial (P/S) converter 611, the outputs of which are then transmitted out through the communication network unit antenna.

The spreading gain G for each cluster depends on the variation of the channel response measured for the communication devices within the cluster. In a case where fast fading is encountered, it is recommended that smaller spreading gains should be applied.

FIG. 7 shows a block diagram of a downlink path transmitter 700 with another implementation of block spreading, according to an embodiment of the invention.

Similar to the implementation shown in FIG. 6, the modulated symbols from communication device (or user) k are first passed to a serial to parallel (S/P) converter 701, generating Nₖ symbol outputs at one time.

However, in this implementation, these symbols are then passed to a carrier signal mapper 703. At the same time, N-Nₖ zeros are inserted (705), passed to a serial to parallel (S/P) converter 707, the outputs of which are passed to a second carrier signal mapper (709). The outputs of the carrier signal mappers (703 and 709) are then processed by an OFDM modulator 711, the output of which is then passed to a block spreading block 713 with processing gain of G, generating G chip blocks.

In a comparison between FIG. 6 and FIG. 7, it can be seen that there is no insertion of N-Nₖ zeros in the implementation of FIG. 6, but there is an insertion of N-Nₖ zeros in the alternative implementation of FIG. 7. The reason for this is as follows.

In the implementation shown in FIG. 6, the chip blocks from each communication device (or user) with the same cluster are summed up, to form the summed chip blocks. Similarly, the summed chip blocks are formulated for the other clusters. The summed chip blocks from each cluster are then passed to the respective carrier signal mappers 607, followed by the OFDM modulator 609. Since all data symbols from different users are passed to carrier signal mappers 607, accordingly, no insertion of N-Nₖ zeros is required in this implementation.

In the implementation shown in FIG. 7, since the block spreading is only performed after the carrier signal mappers (703 and 709), it is required to insert N-Nₖ zeros to fit into total N carrier signals before being passed through the OFDM modulator 711. Basically, the difference between the respective implementations shown in FIG. 6 and in FIG. 7 is due to the difference in the way how the functional blocks are sequenced in the respective implementations.

The above processing is repeated for all communication devices. Finally, the chip blocks for all users are summed up (715), the outputs are then processed by a parallel to serial (P/S) converter 717, and finally transmitted out through the communication network unit antenna.

FIG. 8 shows a block diagram of a transmitter 800 with an implementation of block spreading along with a pre-transform block 803, according to an embodiment of the invention.

In this simple illustration, the mapped symbols from a communication device are first converted to parallel symbols by a serial-to-parallel (S/P) conversion block 801, and fed into the pre-transform (PT) block 803. The pre-transformed symbols are then passed to the OFDMA modulator 805. The modulated data are then block spread (807) before being transmitted.

The pre-transform (PT) block may be implemented using a pre-transform matrix. Pre-transformation of mapped symbols before OFBMA modulation is to spread each data symbols to many, if not all carrier signals. Pre-transformation can achieve various performance gains subject to the selection of the pre-transform matrix.

In the uplink transmission, the size of the pre-transform matrix used is typically the same as the number of carrier signals allocated to the communication device. Hence, the size of the pre-transform matrix used in the uplink transmission is typically smaller than the size of the fast Fourier transform (FFT) matrix.

In the downlink transmission, the pre-transform matrix size may be as small as the smaller sized pre-transform matrix of the uplink transmission, or as big as the bigger sized FFT matrix (as shown in FIGS. 9 and 10, for example).

The selection of a different pre-transform matrix may lead to different aspects in performance gains. For example, if the pre-transform matrix is selected to be a Walsh Hadamard matrix, the peak to average power ratio (PAPR) of a system using pre-transform will be reduced significantly compared to the PAPR of a system without using pre-transform.

Also, if the pre-transform matrix is selected to be a Fourier transform matrix, the system becomes a single carrier FDMA system with frequency domain implementation. The PAPR in this case is further reduced, as compared to the case when the Walsh Hadamard matrix is selected as the pre-transform matrix.

If the pre-transform matrix is a unitary matrix being product of Fourier transform and a phase rotation diagonal matrix, the error symbol events at the corresponding receiver will be well distributed. This could be exploited to achieve better bit error rate performance. It is noted that if the pre-transform matrix is selected to be an identity matrix, the pre-transform block spreading (PT-BS) OFDMA system would be reduced to an OFDMA system with block spreading.

FIG. 9 shows a block diagram of a downlink transmitter 900 with an implementation of block spreading along with a pre-transform block 903, according to an embodiment of the invention.

The labeled items of FIG. 9 correspond to those of FIG. 8.

In FIG. 9, the mapped symbols from a communication device are first converted to parallel symbols by a serial-to-parallel (S/P) conversion block 901. After that, the parallel mapped symbols from all communication devices are input into a pre-transform block 903 to be pre-transformed. Accordingly, the pre-transform matrix in this implementation is relatively large.

FIG. 10 shows a block diagram of a downlink transmitter 1000 with another implementation of block spreading along with a pre-transform block 1003, according to an embodiment of the invention.

The labeled items of FIG. 10 correspond to those of FIGS. 8 and 9.

In FIG. 10, the mapped symbols from a communication device are first converted to parallel symbols by a serial-to-parallel (S/P) conversion block 901. After that, the parallel mapped symbols from each communication devices are input into a pre-transform block 1003 to be pre-transformed. This means that each communication device has its own pre-transform block 1003. Accordingly, the pre-transform matrix in this implementation may be relatively smaller, as compared to the case in FIG. 9.

In this implementation, all pre-transformed symbols are then input into the OFDMA modulator 1005, to be formed into OFDMA symbols.

The embodiments which have been described in the context of the method for transmitting data between a communication network unit and a plurality of communication devices provided, are analogously valid for the device.

What is claimed is:

1-26. (canceled)

27. A method for transmitting data between a communication network unit and a plurality of communication devices comprising
using a plurality of carrier signals grouped into at least one carrier signal group,
determining a subset of communication devices of the plurality of communication devices, and
using the at least one carrier signal group for data transmission between the communication network and the communication devices of the subset of communication devices.

28. The method of claim 27, wherein a number of communication devices to which the at least one carrier signal group should be allocated is determined and the subset of communication devices of the plurality of communication devices is determined such that it comprises the number of communication devices.

29. The method of claim 28, wherein a transmission characteristic of a communication channel used for transmission of at least one of the carrier signals of the at least one carrier signal group is determined.

30. The method of claim 29, wherein the number of communication devices to which the at least one carrier signal group should be allocated is determined based on the transmission characteristic.

31. The method of claim 29, wherein the transmission characteristic is measured and the subset of communication devices is determined based on the transmission characteristic at least substantially fixed time intervals.

32. The method of claim 29, wherein the transmission characteristic is the channel response of the communication channel.

33. The method of claim 29, wherein the number of communication devices is being dynamically adjusted based on the transmission characteristic determined comprising
determining the transmission characteristic for each communication device in the subset of communication devices,
determining the largest difference between the transmission characteristics of a pair of communication devices,
determining, whether the largest difference between the transmission characteristics of a pair of communication devices is below a predetermined threshold,
in case the largest difference between the transmission characteristics of a pair of communication devices is below a first predetermined threshold, then the number of communication devices being increased,
in case the largest difference between the transmission characteristics of a pair of communication devices is above the first predetermined threshold, but is below a second predetermined threshold, then the number of communication devices being unchanged, and
in case the largest difference between the transmission characteristics of a pair of communication devices is above the second predetermined threshold, then the number of communication devices being decreased.

34. The method of claim 27, wherein to each communication device of the subset of communication devices a set of spreading sequences is allocated and the data transmitted between the communication network unit and the communication device using the at least one carrier signal group is spread using the set of spreading sequences, wherein the set of spreading codes comprises at least one spreading code.

35. The method of claim 34, wherein the set of spreading sequences allocated to each communication device of the subset of communication devices being different from all the sets of spreading sequences allocated to other communication devices of the subset of communication devices.

36. The method of claim 35, wherein the set of spreading sequences allocated to each communication device of the subset of communication devices being orthogonal or at least substantially orthogonal from all the sets of spreading sequences allocated to other communication devices of the subset of communication devices.

37. The method of claim 34, wherein a transmission characteristic of a communication channel used for transmission of at least one of the carrier signals of the at least one carrier signal group is determined and the length of the spreading sequences allocated to each communication device of the subset of communication devices is chosen according to the transmission characteristic of the communication channel.

38. The method of claim 27, wherein the at least one carrier signal group forms a contiguous frequency range.

39. The method of claim 27, further comprising using a multiple access transmission technology.

40. The method of claim 39, wherein the multiple access transmission technology is at least one of the following:
code division multiple access, and
orthogonal frequency division multiple access.

41. The method of claim 27, the communication network unit being a mobile radio base station.

42. The method of claim 27, further comprising grouping the plurality of carrier signals into at least one carrier signal group.

43. The method of claim 27, further comprising
arranging the data symbols of the data transmission into a data symbol block, and
multiplying the data symbol block with a pre-transform matrix.

44. The method of claim 43, wherein the pre-transform matrix is selected from a group comprising a Walsh Hadamard matrix, a Fourier transform matrix, or a unitary matrix being product of a Fourier transform matrix and a phase rotation diagonal matrix.

45. The method of claim 27, at least one communication device being a wireline communication device.

46. The method of claim 27, at least one communication device being a powerline communication device.

47. The method of claim 27, at least one communication device being a radio communication device.

48. The method of claim 27, at least one communication device being a mobile radio communication device.

49. The method of claim 27, at least one communication device being a satellite radio communication device.

50. The method of claim 27, at least one communication device being a terminal communication device.

51. The method of claim 27, at least one communication device being a Consumer Premise Equipment device.

52. A device for allocating a plurality of carrier signals grouped into at least one carrier signal group for transmitting data between a communication network unit and a plurality of communication devices comprising
a determining unit determining a subset of communication devices of the plurality of communication devices, and
an allocating unit allocating the at least one carrier signal group for data transmission between the communication network and the communication devices of the subset of communication devices.
